(19) United States
(12) Patent Application Publication
(10) Pub. No.: US 2002/0158393 A1
(43) Pub. Date: Oct. 31, 2002

(54) Spring carrier

(75) Inventors: Gunther Handke, Euerbach (DE); Gerald Fenn, Pfersdorf (DE)

Correspondence Address: Thomas C. Pontani, Esq., Cohen, Pontani, Lieberman & Pavane, Suite 1210, 551 Fifth Avenue, New York, NY, 10176, US

(73) Assignee: ZF Sachs AG

(21) Appl. No.: 10/124,886

(22) Filed: Apr. 18, 2002

(30) Foreign Application Priority Data
Apr. 26, 2001 (DE) 101 20 415.9

(51) Int. Cl. B60G 15/00; F16F 11/00

(52) U.S. Cl. 267/221; 188/322.19

(57) ABSTRACT

A spring carrier includes a cylinder tube and a spring plate mounted on a sleeve relative to the cylinder tube. The spring plate is mounted so that the spring plate is vertically adjustable relative to the cylinder tube by changing the effective length of the sleeve.

### BACKGROUND OF THE INVENTION

1. Field of the Invention

The present invention is directed lo a spring carrier having a cylinder and a spring plate mounted on a sleeve relative to the cylinder tube.

2. Description of the Related Art

German reference DE 195 06 699 A1 (DE '699), discloses a cylinder whose base has a rim which forms a support surface for a spring plate (see FIGS. 4a to 4c of DE '699). The rim is completely flat and a sleeve portion of the spring plate is likewise constructed with a flat end face, so that the spring plate can be rotated relative to the cylinder.

German reference DE 44 09 661 C1 describes a spring carrier in a vibration damper construction in which a sleeve portion of the spring plate is welded to the base of the spring carrier. Alternatively, a spring plate may also be a component part of a connection member.

A spring strut disclosed in German reference DE 195 15 643 C1 discloses a spring plate supported on a sleeve portion of a stabilizer holder which is held in turn by at least one bead of the container tube. The stabilizer holder and the sleeve portion form an integral

In above-cited prior art, the spring plates may be mounted axially in only one vertical position. While vertically adjustable spring plates are described, e.g., in German references DE 43 40 494 A1 or DE 25 56 707 A1, none of these references disclose how to fasten a mounted part for supporting the spring plate, particularly in spring carriers that are constructed on the principle of single-tube vibration dampers, without deformations occurring at the spring carrier which can render the inner wall of the cylinder tube unusable as a running path for a piston.

### SUMMARY OF THE INVENTION

It is the object of the present invention to realize a vertically adjustable spring plate for a spring carrier which avoids the problems known from the prior art with respect to possible deformation of the cylinder.

According to the present invention, the object is met in that a spring plate is mounted so as to be vertically adjustable relative to a cylinder tube by changing the effective length of a sleeve.

A vertical adjustment of the spring plate may be carried out in a comparatively simple manner proceeding from a support surface. No special steps need to be taken with respect to the cylinder tube.

Accordingly, the sleeve may be a component part separate from the spring plate. A vertical adjustment can be achieved in a very simple and reliable manner simply by exchanging the sleeves for different lengths.

According to another advantageous embodiment, the sleeve is supported on a connection member which has a radial projection relative to the cylinder tube. This allows the cylinder tube to be produced without radial deformations for a support surface over its entire length.

When constructed as an articulated eye, the connection member comprises an articulated sleeve having a support surface for the sleeve.

In one embodiment, the sleeve has a stepped end face in the direction of the articulated eye, so that different parts of the end face can be made to engage with the support surface of the connection member by a rotating movement about its vertical axis. A number of effective length settings may be achieved with one sleeve.

The contour of the end face of the sleeve is formed by circle sections of various depth. In this way, the sleeve is prevented from rotating in circumferential direction.

It is already known to arrange spring plates at all inclination to the longitudinal axis of the spring carrier. However, this results in the problem that the spring plate must be secured in circumferential direction. Simple protection against rotation for the sleeve is not sufficient in this case. Therefore, the sleeve has a quantity of positive engagement segments in the direction of the spring plate which enter into a positive connection with the spring plate. When there is direct contact between a spring and a spring plate, noises can occur due to a relative movement in the suspension process. Previously, for example, flexible bases were used for the springs or the springs were coated. This problem can be circumvented in that the spring plate is formed of plastic.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is an overall view of the spring carrier having a spring plate according to an embodiment of the present invention;

FIG. 2 is a detail section of the spring carrier of FIG. 1 with a connection member of the spring carrier;

FIG. 3 is a plan view of a spring plate of FIG. 1;

FIG. 3a is a perspective view of the spring plate of FIG. 3;

FIG. 4 is a sectional view of the spring plate along line IV-IV in FIG. 3;

FIG. 5 is a sectional view of the spring plate along line VI-VI in FIG. 3;

FIG. 6 is a sectional view of the spring plate along line V-V in FIG. 3;

FIG. 7 is a sectional view of a spring plate according to another embodiment of the present invention having a separate sleeve; and

FIG. 8 is a side view of the sleeve of FIG. 7.

### DETAILED DESCRIPTION OF THE PRESENTLY PREFERRED EMBODIMENTS

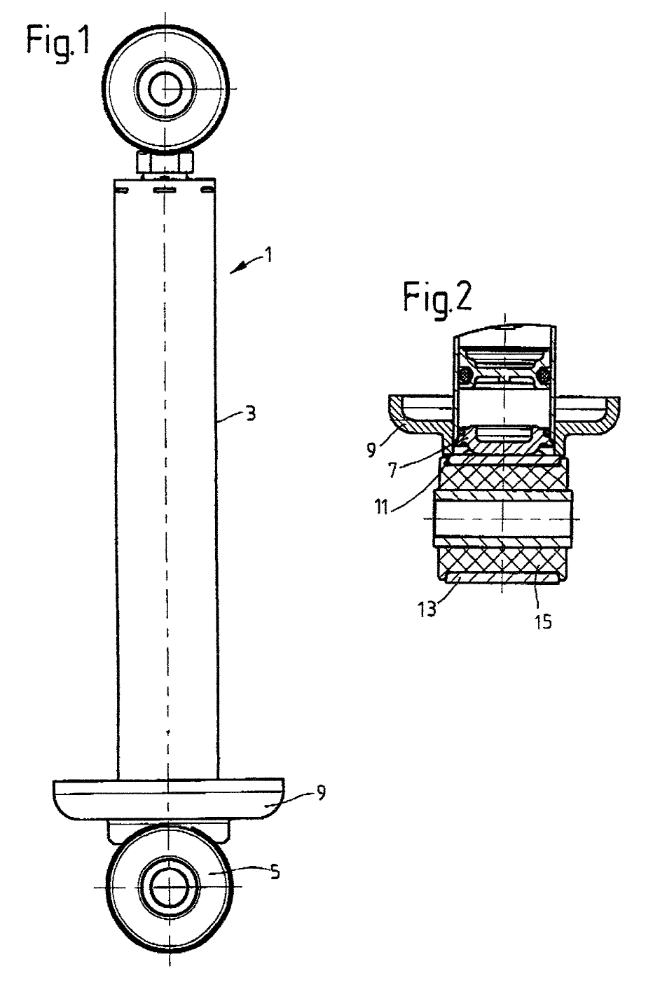

FIG. 1 shows a spring carrier 1 such as that used, for example, as a vibration damper in a motor vehicle or as a pneumatic spring in a vehicle hood. The spring carrier 1 comprises a cylinder tube 3 with a connection member 5 which is fastened to a base 7 (FIG. 2) of the cylinder tube 3. A spring plate 9 for a helical compression spring (not shown) is mounted on a support surface 11 so that the spring plate is stationary in the axial direction relative to the cylinder tube 3.

FIG. 2 shows that the connection member 5 is constructed as an articulated eye and has an articulated sleeve 13. The articulated sleeve 13 includes a radial projection relative to the cylinder tube 3. That is, the surface of articulated sleeve 13 is not flat but projects toward the cylinder tube. This radial projection of the articulated sleeve 13 forms the support surface 11. The cylinder tube 3 itself contains no radial projections for mounting the spring plate 9. An elastomer bushing 15 which is longer than the articulated sleeve 13 is pressed into the articulated eye. The elastomer bushing 15 can form the support surface and permits a defined angular movability of the spring plate.

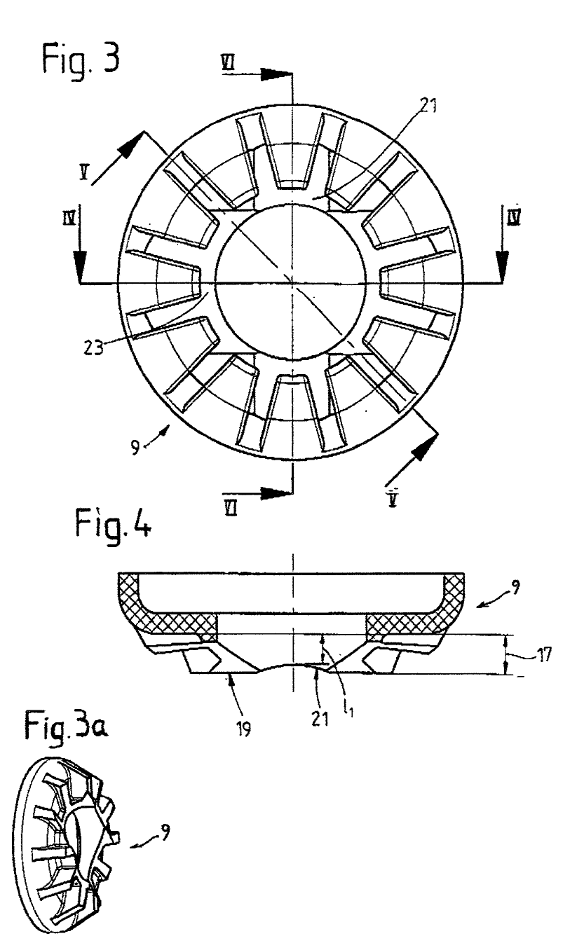

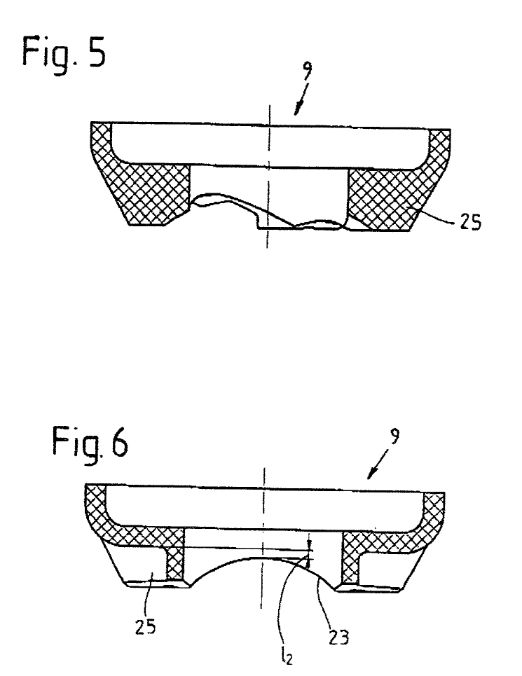

FIGS. 3 to 6 show a plan view, a perspective view, and different sections through the spring plate 9 which has a sleeve 17. The spring plate 9 is mounted so that it is vertically adjustable relative to the cylinder tube 3 by changing its effective length. An end face 19 of the sleeve 17 is constructed so as to be stepped in the direction of the articulated eye of the connection member 5 in that the contour is formed by circle sections 21; 23 of different depth (see FIGS. 4 and 6). The effective length of the sleeve 17 may be adjusted by rotating the spring plate 9 on the articulated sleeve 13. Due to the contour of the end face 19 with circle sections 21, 23, the sleeve 17 is prevented from inadvertently rotating, for example, due to vibrations, because of the positive engagement between the end face 19 and the articulated sleeve 13 that is effective in both rotating directions. The change in effective length is determined by the difference in depth (1₁−1₂) of the circle sections 21, 23.

For noise insulation and for weight reasons, the spring plate 9 is produced from plastic. To provide adequate strength, the spring plate 9 has a plurality of supporting ribs 25 extending from the underside of the spring plate 9 in the direction of the sleeve 17. The spring plate 9 does not contain any undercuts so that it is possible to remove the injection-molded spring plate 9 from the mold especially easily. In this embodiment, the sleeve 17 and spring plate 9 form a single constructional unit.

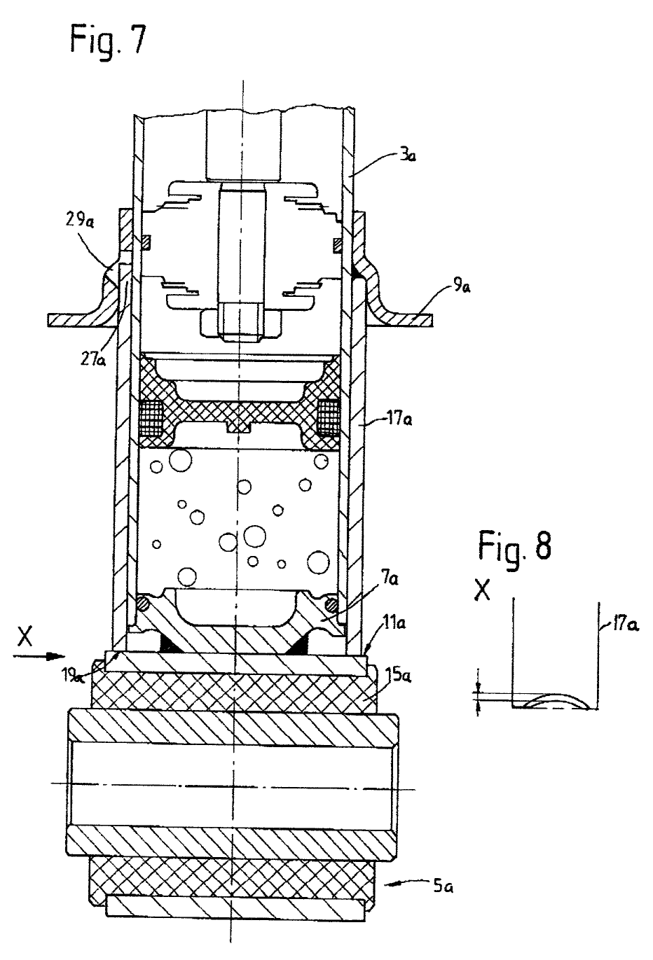

FIG. 7 shows a spring carrier 1a with a cylinder tube 3a in which a sleeve 17a forms a component part that is separate from a spring plate 9a. The effective length of the sleeve 17a is defined by simple exchange of the sleeve. Of course, a contoured end face 19a may be provided such as the contoured end face 19 shown in FIGS. 4 and 6. When the spring plate 9a is arranged at an inclination to the longitudinal axis of the spring carrier lathe spring plate 9a should be fixed in circumferential direction relative to the cylinder tube 3a, i.e., rotation of the spring plate 9 about the cylinder tube 3a should be prevented. When this is required, the sleeve 17a may include a quantity of positive engagement segments 27a in the direction of the spring plate 9a which enter into a positive engagement connection with the spring plate 9a. In this embodiment, the positive engagement segments 27a are formed by tongues which engage in corresponding cutouts 29a in the spring plate 9a. In this case, the cutout 29a in the spring plate 9a receives a tongue which constitutes a partial elongation of the sleeve 17a. The spring plate 9a is weakened in cross section only to a negligible extent. When the sleeve 17a is rotated for vertical adjustment, the spring plate 9a is rotated back again relative to the sleeve 17a by the same angular degree, wherein it is assumed that the quantity and angular settings of the positive engagement segments 27a with the cutouts 29a are aligned with the circle sections 21a; 23a at the opposite end face 19a.

FIG. 8 shows a detailed view according to view “X” in the area of the lower end of the sleeve 17 illustrating the possibility of vertical adjustment and shows the two different radius of the contour 19. The difference in radius indicated by the arrows describes the adjusting range.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A spring carrier, comprising:
a cylinder tube having a longitudinal axis;
a spring plate mounted on a sleeve supported relative to said cylinder tube, wherein a position of said spring plate along the longitudinal axis of said cylinder tube is adjustable by changing an effective length of said sleeve.

2. The spring carrier of claim 1, wherein said sleeve and said spring plate comprise separate component parts.

3. The spring carrier of claim 1, further comprising a connection member connected to said cylindrical tube, said connection member having a radial projection, and said sleeve being supported on said connection member.

4. The spring carrier of claim 3, wherein said connection member comprises an articulated eye including an articulated sleeve having a support surface for supporting said sleeve.

5. The spring carrier of claim 4, wherein said sleeve has a stepped end face confrontingly opposed to said support surface on said connection member and comprising different parts, such that said different parts of said end face selectively engage said support surface in response to a rotating movement about a vertical axis of said sleeve for changing the effective length of said sleeve.

6. The spring carrier of claim 5, wherein said different parts of said contour of said end face comprises different circle sections of various depth.

7. The spring carrier of claim 2, wherein said sleeve comprises a plurality of positive engagement segments facing said spring plate which enter into a positive connection with said spring plate.

8. The spring carrier of claim 1, wherein said spring plate is plastic.
